(19) United States
(12) Patent Application Publication
(10) Pub. No.: US 2016/0072237 A1
(43) Pub. Date: Mar. 10, 2016

(54) Electric Guitar cable

(71) Applicant: Baoshan Han, Dallas, TX (US)

(72) Inventor: Baoshan Han, Dallas, TX (US)

(21) Appl. No.: 14/656,740

(22) Filed: Mar. 13, 2015

Related U.S. Application Data
(60) Provisional application No. 62/070,922, filed on Sep. 9, 2014.
(60) Provisional application No. 62/070,925, filed on Sep. 9, 2014.

(51) Int. Cl. H01R 24/58; G10H 1/46

(52) U.S. Cl. CPC H01R 24/58; G10H 1/46; H01R 2103/00

(57) ABSTRACT

A guitar cable for connecting a guitar to an amplifier may include the guitar having a guitar output connector to connect to the guitar cable and an audio source having and audio output connector to connect to the guitar cable, and the guitar cable having an input guitar connector to connect to the guitar output connector, the guitar cable having an audio input connector to connect to the audio output connector, and the input guitar connector being connected to the audio input connector and connected to the output guitar connector and the output guitar connector being connected to the amplifier input connector of the amplifier.

### PRIORITY

The present invention claims priority under 35 USC section 119 based upon provisional applications having serial numbers 62070922 and 62070925 both of which were filed on Sep. 9, 2014.

### FIELD OF THE INVENTION

This invention relates to an electric guitar cable, a portable electronic device, such as, a smart phone, an MP3 player, a tablet etc which may be the source of audio signals to be amplified.

### BACKGROUND

Conventional (electric) guitar cable takes the signal from the electric guitar pickup circuits and transmits the signal to an amplifier. Both ends of the cable may terminate in the standard ¼ inch (6.35 mm) plugs with two wired screened/shielded cable in between. This arrangement is limited to amplifying signals from the guitar.

### SUMMARY

However, with the popular use of portable audio devices, such as smart phones, MP3 players, and other type of portable electronic devices, and especially when digital music tracks, loops, and music training, teaching videos, are readily available on these devices, it's desirable that both the guitar playing signals from the guitar and audio signals from these portable devices in the player's hands or pockets, can be combined and fed into the amplifier, so that the player can either learn how to play from a training video and compare the sound effect on the same amplifier, or the player can play a piece of music with the guitar and have accompaniment tracks, music loops from the audio devices.

The present invention provides the player the convenience of connecting and controlling the electric guitar and the portable audio device signals, in a way the user may desire, right where he is at any moment at his fingertips.

This invention relates to an electric guitar cable, the electric guitar cable transmits the electric guitar signal generated from the electro-magnetic coil pickup circuits through a first male plug which may be a ¼ inch (6.35 mm) plug, and another audio signal generated from an electronic device, such as, a smart phone, an MP3 player, a tablet etc. transmitted through a second male plug which may be a 3.5 mm male plug and combines both signals, into a single combined signal and transmits the combined signal into an electric guitar amplifier via a receiving male plug which may be ¼ inch (6.35 mm) male plug on the other end.

More particularly, a volume control, or a variable resistor, may be connected in series to the second male plug, so the strength of the second audio signal can be varied/adjusted before it is mixed with the electric guitar signal from the electric guitar, and fed into the electric guitar amplifier.

This cable can also be used with electric acoustic guitars.

A guitar cable for connecting a guitar to an amplifier may include the guitar having a guitar output connector to connect to the guitar cable and an audio source having an audio output connector to connect to the guitar cable, and the guitar cable having an input guitar connector to connect to the guitar output connector, the guitar cable having an audio input connector to connect to the audio output connector, and the input guitar connector being connected to the audio input connector and connected to the output guitar connector and the output guitar connector being connected to the amplifier input connector of the amplifier.

The audio source may be a smart phone.

The audio source may be an MP3 player.

The audio source may be a tablet

The input guitar connector may be a ¼ inch (6.35 mm) plug.

The input audio connector may be a 3.5 mm plug.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a circuit diagram of the present invention;

FIG. 2 illustrates a circuit diagram of two pick circuits used on electric guitars;

FIG. 3 illustrates a perspective view of the electric guitar including the face plate of an electric guitar with the integrated female audio input jack socket of the present invention;

FIG. 4 illustrates a circuit diagram of the present invention;

FIG. 5 illustrates a perspective view of the cable of the present invention;

FIG. 6 illustrates a perspective view of the cable of the present invention.

### DETAILED DESCRIPTION

The method and the system of the present invention centers around the concept of creating two interfaces, or plugs, on one end of the cable to take electric signals from the pickup circuits of the electric guitar and the electric signals from the audio devices, and to combine them into one signal being transmitted to the amplifier via one output interface, another plug, on the opposing end of the cable.

The interface which takes the electric guitar signals uses the male plug which may be ¼ inch (6.35 mm), and the audio interface which uses the audio male plug which may be 3.5 mm and includes volume control which may use a potential meter with an variable resistor of 500 k Ohm, and the two-wire screened/shielded cables from both the guitar signal interface and the audio interface being parallel connected.

The volume control in the section of the audio interface controls the level of the output of the audio signal before it is mixed with the electric guitar signal with respect to its positions between the maximum and minimum.

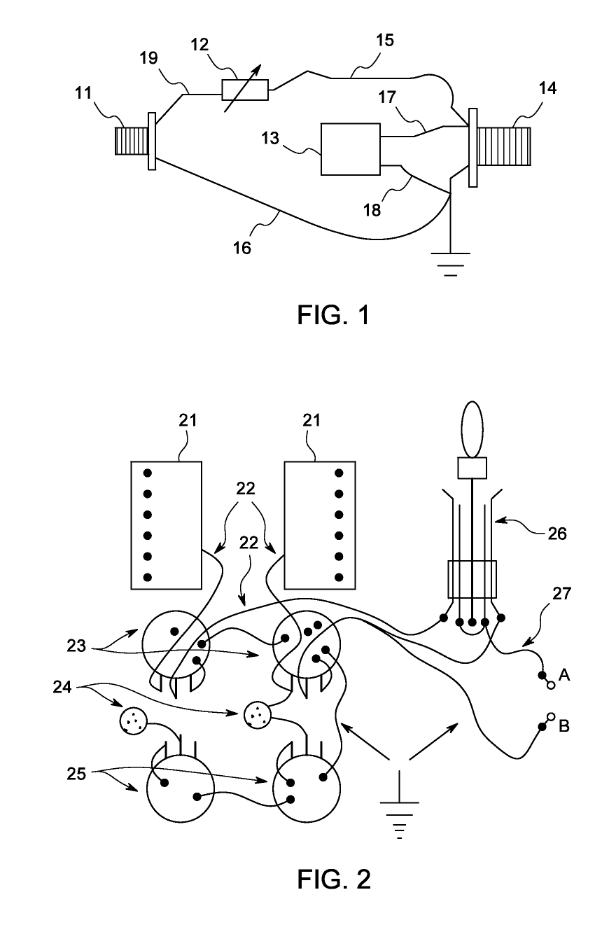

FIG. 1 is an illustration of the system of the present invention showing a diagram of the circuitry of the volume controlled audio jack socket 11 integrated with the guitar pickup circuit at the guitar output jack socket.

Referring to FIG. 1, a female audio jack socket 11 which may be 3.5 mm is connected to the guitar output jack socket 14 which may be ¼ inch (6.35 mm) in parallel with wire 16 which may be on the ground side, and wire 19, volume control 12, wire 15 which may be connected in series on the hot side.

Electro-magnetic pickup circuit and control circuit 13 (as shown in FIG. 2) are connected to the electric guitar output jack socket 14 through the wire 17 on the hot side, and wire 18 on the ground side.

FIG. 2 illustrates two pick circuits used on electric guitars.

Referring to FIG. 2, a pair of mirrored pickup circuits 21 may be used in the present invention. The pickup circuits 21 may be connected to a pair of volume controls 23 (each connected to one of the pickup circuits 21) to allow the user to vary the volume output by the guitar and a pair of tone controls 25 (each connected to one of the pickup circuits 21) to allow the user to vary the tone output by the guitar via screened/shielded cables 22. A pair of capacitors 24 may be connected to the tone controls 25 and volume controls 23 to provide power for the tone controls 25 and the volume controls 23. A three way toggle switch 26 may be connected to the two pickup circuits via the two volume controls so that the three positions of the three-way toggle switch 26 may selectively determine whether one pickup circuit is selected, the other pickup circuit is selected for both pickup circuits are selected simultaneously. Hot wire 27 may be connected to the hot side A of the guitar port 14 which may be ¼ inch (6.35 mm). Jack socket contact B of guitar port 14 is ground.

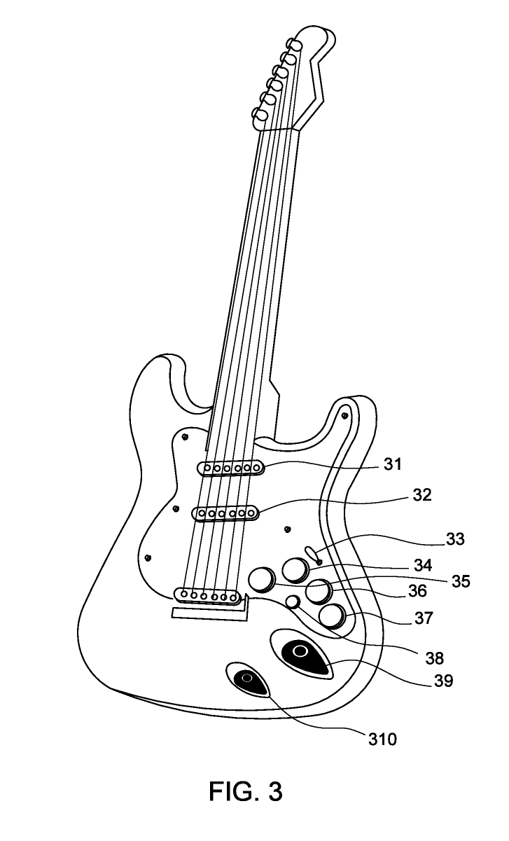

FIG. 3 shows a perspective view of the face plate of an electric guitar with the integrated female audio input jack socket of the present invention. FIG. 3 depicts a perspective view of the electric guitar. The two pickup circuits 31 and 32 are positioned under the steel strings of the guitar. The three way toggle switch 33 controls which pickup circuit to use. Volume controls 34 and 35 are for tuning the signal strength of each of the pickup circuits 31 and 32. Tone controls 36 and 37 are for controlling the tones of either pickup circuit 31 and 32. Volume control 38 is for tuning the audio signals from the audio devices coming in through the female audio jack socket 310 which may be 3.5 millimeter before mixing with the electric guitar signal. The mixed signal (mixing the audio signal with the guitar signal) may be transmitted to the amplifier via the output jack socket 39 which may be ¼ inch (6.35 mm) through a guitar cable (not shown).

With the present invention, terminals, plugs, sockets are considered connectors or electrical connectors.

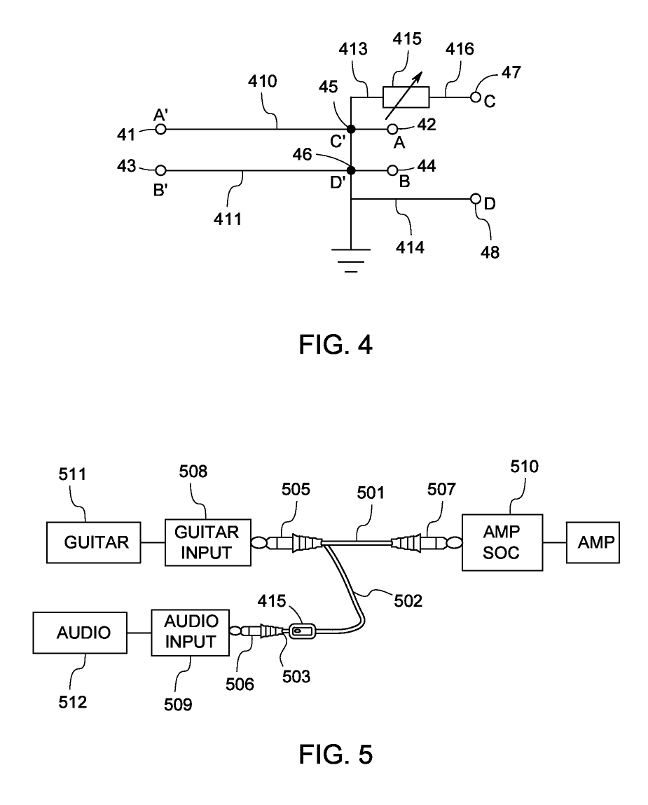

FIG. 4 illustrates a circuit diagram of the system of this invention showing the circuitry of the two screened/shielded cable wires.

FIG. 5 depicts a perspective view of the cable.

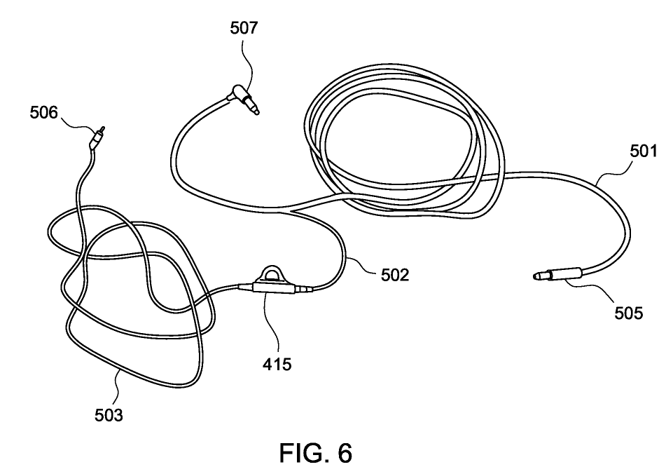

FIG. 6 shows a perspective view of the cable of the present invention.

Referring to FIG. 4, terminal 41 may be connected to conductor 410 which may be connected to terminal 42, and terminal 43 may be connected to conductor 411 which may be connected to terminal 44 which may represent the two wires within the screened/shielded cable of the guitar cable. Terminal 42 and terminal 44 may represent the two contact points on the guitar cable male plug which may be ¼ inch (6.35 mm). Terminal 47 and terminal 48 may connect the two wires shown as connectors 416, 414 within the screened/shielded cable of the audio cable. A volume control or a variable resistor (R) 415 which may be approximately (500K Ohm) may be connected in series between conductor 413 and conductors 416.

Terminal 47 and terminal 48 may represent the two contact points on the audio male plug which may be in 3.5 mm. Terminal 45 and terminal 46 may represent the solder point where the two screened/shielded cables are physically connected via soldering. Terminal 43, terminal 46 and terminal 48/Contact points B, B′ and D may be connected to ground or referred to as a grounded contact points.

In the same way, terminal 41 and terminal 43 may be the two contact points on the guitar cable male plug which may be the ¼ inch (6.35 mm).

FIG. 5 illustrates a perspective view of the cables, guitar plug, and an audio plug and illustrates the first cable 501 may be connected between the first guitar plug 505 and the second guitar plug 507. The second cable 502 may be connected between the first guitar plug 505 and the volume control 415 (or the variable resistor), and the audio plug 506 may be connected to the third cable 503 which may be connected to the volume control 415.

FIG. 5 additionally illustrates that the guitar plug 505 may be connected to the guitar output socket 508 for connection to the guitar 511. Likewise, the audio plug 506 may be connected to the audio input output socket 509 on the audio device, and the guitar plug 507 may be connected to the amplifier socket 510.

FIG. 6 illustrates a perspective view of the cables, guitar plug, and an audio plug and illustrates the first cable 501 may be connected between the first guitar plug 505 and the second guitar plug 507. The second cable 502 may be connected between the first guitar plug 505 and the volume control 415 (or the variable resistor), and the audio plug 506 may be connected to the third cable 503 which may be connected to the volume control 415.

### OPERATION

In operation, the user inserts the male plug which may be ¼ inch (6.35 mm) on one end of the guitar cable into the electric guitar port and inserts the opposing male plug which may be ¼ inch (6.35 mm) on the other end of the cable into an amplifier. The user may insert the audio male plug which may be 3.5 mm on one end of the audio cable into the audio port on the guitar and inserts the opposing male plug which may be 3.5 mm into an audio device, such as a smart phone, an mp3 player, or a tablet or other appropriate device. The signal strength from the audio device is adjusted by the volume control for the audio jack port, and the guitar pickup circuits signal strength is adjusted by the volume controls for the guitar output jack port, as well as tone controls for each pickup circuit. The user can get a satisfying sound effect from the amplifier . . . .

And, using the guitar cable of the present invention, the user inserts the male plug which may be ¼ inch (6.35 mm) on one end of the guitar cable into the electric guitar port and inserts the opposing male plug which may be ¼ inch (6.35 mm) on the other end of the cable into an amplifier. The user may insert the audio male plug which may be 3.5 mm on the end of the audio cable into an audio device, such as a smart phone, an mp3 player, or a tablet or other appropriate device. The signal strength from the audio device is adjusted by the volume control on the audio cable and the guitar pickup circuits signal strength is adjusted by the volume controls for the guitar output jack port, as well as tone controls for each pickup circuit. The user can get a satisfying sound effect from the amplifier . . . .

Thus, the mixed signals electric guitar pickup system (and the guitar cable) is described. It allows the guitar player to mix the electric guitar signal, an audio signal from an audio device, such as a smart phone, a Metroid Prime 3 (MP3) player, a tablet etc. and then amplify the mixed signals at the electric guitar amplifier through one conventional guitar cable (and one audio cable), or through the specially designed guitar cable of the present invention to achieve the desired results. Therefore, a maximum of two audio signals could potentially be mixed with the electric guitar signal if the two operation schemes are used at the same time.

The audio signal strength is controlled by the volume control on the guitar if a conventional audio cable is used, or the audio signal strength is controlled by the volume control on the audio cable section if the present invention is used, before it is mixed with the guitar signal as one signal going into the amplifier.

Another use of the present invention is that if the user switches to the opposing side of the cable and inserts the side of the cable with the single male plug into the port of the electric guitar, now the opposing side of the cable may have two outputs of the same guitar signal, and one signal may connect to the amplifier and another signal may connect to a recording system (not shown), such as a laptop computer, through the audio plug which may be 3.5 mm. Many other possibilities are available with this cable.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1. A guitar cable for connecting a guitar to an amplifier, comprising:
the guitar having a guitar output connector to connect to the guitar cable;
an audio source having and audio output connector to connect to the guitar cable;
the guitar cable having an input guitar connector to connect to the guitar output connector;
the guitar cable having an audio input connector with a volume control to connect to the audio output connector;
the input guitar connector being connected to the audio input connector and connected to the output guitar connector;
the output guitar connector being connected to the amplifier input connector of the amplifier.

2. A guitar cable for connecting a guitar to an amplifier as in claim 1, wherein the audio source is a smart phone.

3. A guitar cable for connecting a guitar to an amplifier as in claim 1, wherein the audio source is an MP3 player.

4. A guitar cable for connecting a guitar to an amplifier as in claim 1, wherein the audio source is a tablet.

5. A guitar cable for connecting a guitar to an amplifier as in claim 1, wherein the input guitar connector is a ¼ inch (6.35 mm) plug.

6. A guitar cable for connecting a guitar to an amplifier as in claim 1, wherein the input audio connector is a 3.5 mm plug.

7. A female audio jack socket for connecting to an input audio source as in claim 2, wherein the female audio jack socket is a 3.5 mm port.

8. A volume control connected to an audio input connector audio input connector as in claim 1, wherein the volume control is a potential meter with a variable resistor of 500 k Ohm.

9. A volume control connected to a female audio jack socket connected to the guitar output port as in claim 10, wherein the volume control is a potential meter with a variable resistor of 500 k Ohm.

10. A female audio jack socket for connecting to an input audio source, connected to a volume control, or a variable resistor and connected to the guitar output port.
